(19) United States
(12) Patent Application Publication
(10) Pub. No.: US 2020/0263558 A1
(43) Pub. Date: Aug. 20, 2020

(54) HONEYCOMB STRUCTURE INCLUDING ABRADABLE MATERIAL

(71) Applicant: General Electric Company, Schenectady, NY (US)

(72) Inventors: Krishnamurthy Anand, Bengaluru (IN); Raghavendra Rao Adharapurapu, Bangalore (IN); Eklavya Calla, Bengaluru (IN); Surinder Singh Pabla, Greer, SC (US)

(21) Appl. No.: 16/280,261

(22) Filed: Feb. 20, 2019

(51) Int. Cl. F01D 11/12

(52) U.S. Cl. CPC F01D 11/125; F05B 2280/10743; F05B 2280/107; F05B 2240/11

(57) ABSTRACT

Various embodiments include honeycomb structures including an abradable material, and a method of applying such honeycomb structures to steel components of a gas turbine engine in order to reduce rub damage. Particular embodiments include a honeycomb structure having a plurality of cells, each cell of the plurality of cells including a cell wall surrounding a void, and an abradable material within the void of each cell of the plurality of cells, the abradable material including a metallic alloy and hollow particles.

### TECHNICAL FIELD

The present disclosure generally relates to honeycomb structures and abradable materials, and more particularly to honeycomb structures including an abradable material applied to steel components of a gas turbine engine in order to reduce rub damage.

### BACKGROUND

As is convention, abradable materials are used between a moving part and a stationary part in a rotating machine such that one of the parts cuts or rubs a groove into the abradable material. In a gas turbine engine, the abradable material is usually placed on the stationary case (e.g., shroud) and the rotating blades cut/rub a groove into the abradable material. This allows for accommodation of thermal growth and blade creep. However, when the shroud of a gas turbine engine includes a stainless steel as the base material, an increased mismatch of the coefficient of thermal expansion (CTE) between the steel shroud and conventional abradable materials needs to be addressed in order to provide an effective abradable system. These conventional abradable systems fail to account for the high temperature, large gas flow and oxidation prone environment of a gas turbine engine.

### BRIEF SUMMARY

Honeycomb structures including an abradable material and methods of reducing rub damage to a steel part of a turbine engine are disclosed. In a first aspect of the disclosure, a honeycomb structure includes: a plurality of cells, each cell of the plurality of cells including a cell wall surrounding a void; and an abradable material within the void of each cell of the plurality of cells, the abradable material including at least one metallic alloy and a plurality of hollow particles, the at least one metallic alloy including a braze alloy, and the plurality of hollow particles including fly ash particles.

In a second aspect of the disclosure, a honeycomb structure includes: a plurality of cells, each cell of the plurality of cells including a cell wall surrounding a void; and an abradable material within the void of each cell of the plurality of cells, the abradable material including at least one metallic alloy and a plurality of hollow particles, the at least one metallic alloy including MCrAlY—NiAlₓ where M is one or more of Fe, Co and Ni and x is 20% or greater, and the plurality of hollow particles including at least one selected from the group consisting of zinc oxide, silicon oxide, aluminum oxide, zirconium oxide, cerium oxide and hydroxyapatite.

In a third aspect of the disclosure, a method of reducing rub damage to at least one steel part for a turbine engine includes: applying a metallic abradable filled honeycomb structure to the at least one steel part in a location prone to rubbing, the honeycomb structure including a plurality of cells, each cell of the plurality of cells including a cell wall surrounding a void, the metallic abradable including at least one metallic alloy and a plurality of hollow particles and filling the voids of each cell of the plurality of cells.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 is a schematic cut-away view a portion of a gas turbine engine including a blade in close proximity to a casing/shroud.

FIG. 2 schematically illustrates blade wear and shroud cut after rubbing.

FIG. 3 shows a honeycomb structure.

It is noted that the drawings of the disclosure are not necessarily to scale. The drawings are intended to depict only typical aspects of the disclosure, and therefore should not be considered as limiting the scope of the disclosure. In the drawings, like numbering represents like elements between the drawings.

### DETAILED DESCRIPTION

The present disclosure generally relates to honeycomb structures and abradable materials and, more particularly, to honeycomb structures including an abradable material applied to steel components of a gas turbine engine in order to reduce rub damage. As noted above, when the shroud of a gas turbine engine includes a stainless steel as the base material, there is an increased mismatch of the coefficient of thermal expansion (CTE) between the steel shroud and conventional abradable materials. As also noted above, in addition to CTE mismatch concerns, conventional abradable systems fail to account for the high temperature, large gas flow and oxidation prone environment of a gas turbine engine.

Various aspects of the disclosure include a honeycomb structure having an abradable material that addresses the noted CTE mismatch problem associated with conventional stainless steel parts and uses a low cost material while still maintaining high temperature capability (≥1620° F.) even at large gas flows (approx. 1725 lbs per second). Additional aspects of the disclosure include approaches for reducing and/or preventing oxidation of the honeycomb itself. Accordingly, as compared with conventional approaches, damage (e.g., rub damage) and oxidation of steel engine parts can be reduced by utilizing the honeycomb structures of the disclosure. In addition, the decreased susceptibility to damage and oxidation contributes to a longer life expectancy of steel engine parts that utilize the honeycomb structures of the disclosure.

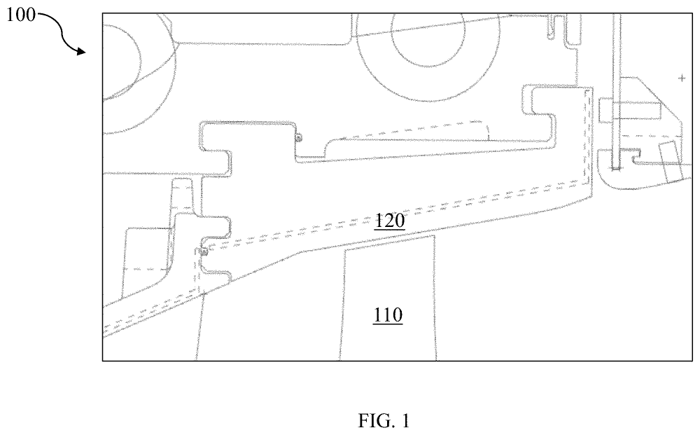

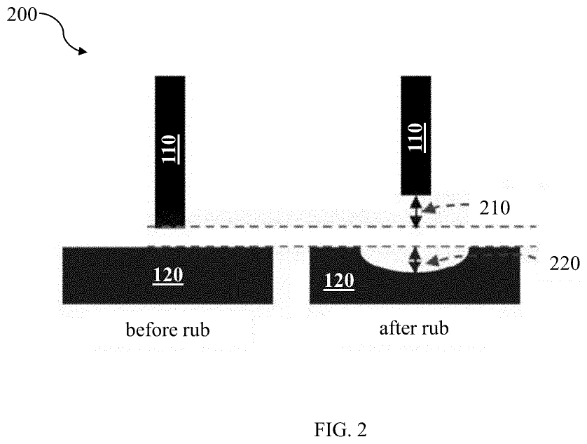

FIG. 1 depicts a section of a gas turbine engine 100 including a blade 110, configured to rotate about a central (or primary) axis, and a stationary casing section 120 (e.g., a shroud) adjacent the blade 110. Without a means for accommodating thermal growth and blade creep, one or both of blade wearing and shroud cutting can occur—this is schematically depicted in FIG. 2. The left-hand diagram (“before rub”) and horizontal dashed lines shown in FIG. 2 depict the clearance between blade 110 and shroud 120 before rubbing and blade wearing/shroud cutting occurs. The right-hand diagram (“after rub”) depicts a blade wear gap 210 and a shroud cut 220 after rubbing. As shown in FIG. 2, blade wear gap 210 and shroud cut 220 markedly increase the original clearance (indicated by horizontal dashed lines) between the blade 110 and the shroud 120. This increased clearance can cause unwanted gaps and airflow leakage that can reduce the overall performance of the engine 100 (FIG. 1).

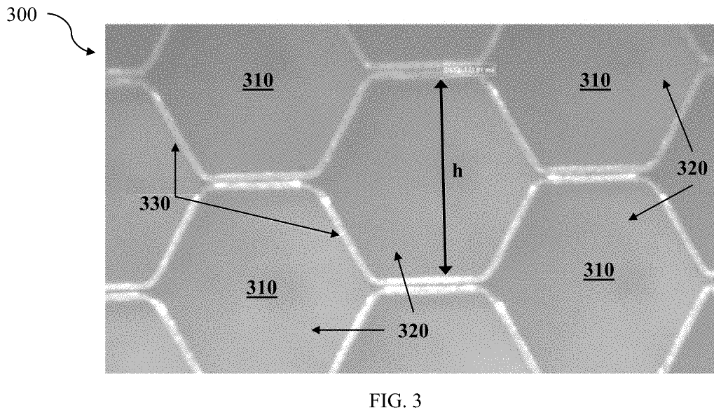

Honeycomb structures can be used for clearance control purposes. Conventional honeycomb structures have a multitude of hexagonal-shaped cells that typically include metallic cell walls with air gaps (voids) in the middle in order to prevent excessive frictional heat and/or wear when rubbing/cutting occurs. However, the air gap within each honeycomb cell can create aero-turbulence (e.g., a rotating eddy) which is a source of aerodynamic loss. Thus, filling the honeycomb cells with an abradable material can be beneficial in that it can eliminate such aerodynamic losses while the honeycomb cell walls can provide structural integrity. Various aspects of honeycomb structures filled with an abradable material are discussed below with reference to FIG. 3.

In aspects of the present disclosure, as depicted in FIG. 3, a honeycomb structure 300 is provided that includes a plurality of cells 320. Each cell 320 has a cell wall 330 surrounding a void 310. Each cell 320 includes a cell size (sometime referred to as a height) “h”. Cell size/height h can include sizes such as, but not limited to, ⅛″, 3/16″, ¼″ and ⅜″ (in millimeters: 3.175, 4.7625, 6.35 and 9.525, respectively). In various aspects, cells walls 330 are metallic, and may include a metallic alloy such as a nickel-based alloy. However, in various aspects, in order to improve oxidation resistance and/or prevention when compared with conventional approaches, cell walls 330 may be provided with an aluminum coating.

In order to reduce or prevent aerodynamic loss, according to various aspects, voids 310 in cells 320 are filled with an abradable material. The abradable material can include at least one metallic alloy and a plurality of hollow particles. The metallic alloy of the abradable material can include any two or more of the following: iron (Fe), nickel (Ni), aluminum (Al), chromium (Cr), titanium (Ti), yttrium (Y) and cobalt (Co). Non-limiting examples of such metallic alloys include a braze alloy or MCrAlY-NiAlₓ, where M is one or more of Fe, Co and Ni and where x is 20% or greater. The hollow particles of the abradable material can include hollow fly ash particles and hollow ceramic particles. Hollow ceramic particles may include, but are not limited to, hollow spheres of zinc oxide, silicon oxide, aluminum oxide, zirconium oxide, cerium oxide and hydroxyapatite.

Regarding hollow fly ash particles, which are primarily made of Al₂O₃ and SiO₂, such particles have a benefit of being a low cost filler. As such, an aspect of the disclosure includes filling voids 310 of cells 320 with an abradable material including hollow fly ash particles that are held together by an active braze alloy. The active braze alloy containing an active element, such as, for example, titanium (Ti), zirconium (Zr), or hafnium (Hf), can wet and bond with metallic surfaces such as the cell walls 330 of cells 320, even if those cell walls include oxides such as aluminum oxide, chromium oxide and silicon oxide. The braze alloy can be, for example, a high-temperature nickel-based active braze alloy. Non-limiting examples of a Ni-based braze alloy are Ni-7Cr-4.5Si-3Fe-3.2B-(0.5-10)Ti, or more specifically, Ni-7Cr-4.5Si-3Fe-3.2B-4.5Ti, where the numerals represent weight % and the balance is nickel (Ni). Such a Ni-based braze alloy can join metal to abradable particles such as hollow particles, including ceramic particles, due to the reaction of the active element with the particle, e.g., the ceramic particle. Additionally, the braze alloy can contain boron (B). When boron (B) is present in the braze alloy, the boron (B) can react and bond with, for example, a silicon oxide ceramic to form various boro-silicate glass phases, thus improving adhesion between the braze and the ceramic particles. The composition of the braze alloy can be selected such that the selected braze alloy has a brazing temperature within a range of from 900° C. to 1200° C.

In an example embodiment, making an abradable material including hollow fly ash particles and a braze alloy, followed by filling of a honeycomb structure is disclosed as follows. A braze alloy can be mixed (e.g., centrifugally) with hollow fly ash particles and an organic binder (e.g., specialty grade organic binders) can be added to the mix. The organic binder(s) can be selected to decompose below the brazing temperature, thereby leaving no residue and allowing for a clean braze joint. To ensure proper brazing (discussed below), the braze alloy used in the mix is preferably in powder form in order to be in full contact with the hollow fly ash particles. Since optimal mixing volume ratios can be selected based on particle size, a 325 mesh (<45 micron particle size) can be used for the braze powder. The resulting mixture can be in the form of a paste which can then be filled into the voids 310 of the honeycomb structure 300, with cell walls 330 containing the mixture (FIG. 3). As mentioned above, the cell walls 330 of honeycomb structure 300 may be provided with an aluminum coating prior to filling.

In various aspects, after filling, the filled honeycomb structure is heat treated. The heat treatment can be performed in two steps, one step to burn off the organic binder and a following step to melt the braze alloy so that it bonds to the cells walls of the honeycomb structure as well as to the particles of the abradable material. Such heat treatment produces a resulting abradable material that is ensconced in the cells of the honeycomb and which has a selected thickness that can range, for example, from 120 mils to 200 mils (1 mil= 1/1000 of an inch). The resulting abradable material has an abradability that is due to both the nature of materials used therein and the porosity which is entrained therein. The porosity being due to the hollow particles, and thus not requiring a pore former to be added to the metallic alloy of the abradable material and further allowing for the use of pore-free metallic alloys.

In another example embodiment of a filled honeycomb structure, the metallic alloy can be MCrAlY (where M is Fe, Ni and/or Co) with NiAlₓ (x≥20%) added thereto as a brittle phase, and the hollow particles can be hollow spheres of zinc oxide. In this embodiment, the zinc oxide constitutes greater than 22% by weight of the total abradable material and contributes to improved abradability of the resulting honeycomb structure. The zinc oxide hollow spheres can account for approximately 40% by weight of the abradable material. As previously noted, the cell walls 330 of honeycomb structure 300 may be provided with an aluminum coating prior to filling with the abradable material. Similar to the prior described embodiment, the resulting abradable material that is ensconced in the cells of the honeycomb can have a selected thickness that can range, for example, from 120 mils to 200 mils.

In yet another embodiment of the disclosure, there is a honeycomb structure including a plurality of cells, where each cell includes a cell wall surrounding a void and where the cell walls include any of the abradable materials discussed above. In other words, the abradable material is patterned to form the cell walls of the cells of the honeycomb structure itself, the honeycomb structure still having voids therein or having the voids therein filled with the abradable material.

The above discussed honeycomb structures of the disclosure that include the noted abradable materials not only address the conventional CTE mismatch problem between, for example, a steel shroud and the abradable material, but can also use a low cost material (e.g., hollow fly ash particles), all while still maintaining high temperature capability (e.g., ≥1620° F.) at large gas flows (e.g., 1725 lbs/sec). Additionally, oxidation reduction and/or prevention of the honeycomb itself can be provided (e.g., if aluminided), when considered relative to conventional structures. All of these features of the honeycomb structures of the disclosure contribute to a longer life expectancy of engine parts utilizing such honeycomb, as compared with conventional approaches and resulting structures.

An additional aspect of the disclosure includes a method of reducing rub damage to at least one steel part for a turbine engine, including stainless steel parts such as 304-grade and 310-grade stainless steels. Such a method can include applying, for example, the above-discussed metallic abradable filled honeycomb structure to the steel part in a location that is prone to rubbing. The application of the filled honeycomb structure can include bonding the metallic abradable to a surface of the steel part. Bonding of the metallic abradable to the cells walls of the honeycomb structure can occur prior to or contemporaneously with the bonding of the metallic abradable to the surface of the steel part. The filling of the honeycomb structure and the bonding of the metallic abradable may be performed as follows.

As discussed above, the honeycomb structure contains a plurality of cells, the plurality of cells typically being regularly spaced from one another and typically being hexagonal in shape with a specified cell size (sometimes referred to as height “h”—see FIG. 3). The plurality of cells also typically have a specified cell wall thickness and a specified depth (sometimes referred to as the honeycomb thickness). Accordingly, the volume occupied by a given cell can be readily estimated. Thus, the volume needed to fill each cell of the honeycomb structure along with a predetermined amount of overflow can also be readily determined. Knowing such volumes, a manual or automated system wherein a syringe is fed with a predetermined amount of a slurry of the abradable material may be used to dispense the slurry into the cells of the honeycomb structure. The viscosity of the slurry can be adjusted by taking into consideration the volume and/or weight of the individual components of the abradable material. In an embodiment where an automated system is utilized, the system may be programmed to control the amount of slurry dispensed into each individual honeycomb cell, and may be additionally programmed to move from one cell to the next to ensure that the cells are filled up to a predetermined volume.

In the case of the abradable material including a metallic braze alloy, a minimum of 8 to 12 volume percent of the metallic braze alloy can be used to ensure a continuous contact between the metallic braze particles in order to provide a continuous mesh of the resulting braze joint. Depending on the wettability of the ceramic media (e.g., the hollow fly ash particles) by the braze alloy, and also considering the desired ultimate properties of the abradable, the volume percent of the metallic braze alloy can be increased to as much as approximately 75 volume percent. After the filling of the honeycomb structure, the whole filled honeycomb structure can be brazed in a vacuum furnace with at least 10⁻³ mbar vacuum. After brazing, the brazed structure can be filed down such that the filled honeycomb cell is flush with the honeycomb cell wall height. If desired, the brazed structure can be subjected to an additional heat-treatment cycle before being incorporated into a steel part for, e.g., a turbine engine.

The method of the disclosure for reducing rub damage, when compared with conventional approaches, can reduce rub damage to parts for a turbine engine, including stainless steels parts, while still maintaining high temperature capability (e.g., ≥1620° F.) even at large gas flows (e.g., 1725 lbs/sec), and in some instances utilizing a low cost material in doing so (e.g., hollow fly ash particles). Accordingly, when compared with conventional approaches, the method of the disclosure allows for a longer life expectancy of the parts, which in turn can reduce overall costs associated with a gas turbine engine, such as manufacturing, operating and repair costs.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s). “Substantially” refers to largely, for the most part, entirely specified or any slight deviation which provides the same technical benefits of the disclosure.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

We claim:

1. A honeycomb structure comprising:
a plurality of cells, each cell of the plurality of cells including a cell wall surrounding a void; and
an abradable material within the void of each cell of the plurality of cells, the abradable material including at least one metallic alloy and a plurality of hollow particles, the at least one metallic alloy including a braze alloy, and the plurality of hollow particles including hollow fly ash particles.

2. The structure of claim 1, wherein the braze alloy is an active nickel-based braze alloy having a braze temperature within a range of from 900 C to 1200 C, the active nickel-based braze alloy including at least one active element selected from the group consisting of titanium (Ti), zirconium (Zr) and hafnium (Hf).

3. The structure of claim 1, wherein the braze alloy is Ni-Cr_{7%}—Si_{4.5%}-Fe_{3%}—B_{3.2%}—Ti_{0.5-10%}, the percentages being weight percentages and the balance being nickel (Ni).

4. The structure of claim 1, wherein the abradable material has a thickness within a range of 120 mils to 200 mils.

5. The structure of claim 1, wherein the metallic alloy is free of pores.

6. The structure of claim 1, wherein the cell walls include the abradable material.

7. A honeycomb structure comprising:
a plurality of cells, each cell of the plurality of cells including a cell wall surrounding a void; and
an abradable material within the void of each cell of the plurality of cells, the abradable material including at least one metallic alloy and a plurality of hollow particles, the at least one metallic alloy including MCrAlY-NiAlₓ where M is one or more of Fe, Co and Ni and x is 20% or greater, and the plurality of hollow particles including at least one selected from the group consisting of zinc oxide, silicon oxide, aluminum oxide, zirconium oxide, cerium oxide, and hydroxyapatite.

8. The structure of claim 7, wherein the metallic alloy includes CoNiCrAlY—NiAl_{20%}.

9. The structure of claim 8, wherein the plurality of hollow particles includes zinc oxide, the abradable material including greater than 22% by weight of the zinc oxide.

10. The structure of claim 7, wherein the abradable material has a thickness within a range of 120 mils to 200 mils.

11. The structure of claim 7, wherein the metallic alloy is free of pores.

12. The structure of claim 7, wherein the cell walls include the abradable material.

13. A method of reducing rub damage to at least one steel part for a turbine engine, comprising:
applying a metallic abradable filled honeycomb structure to the at least one steel part in a location prone to rubbing,
the honeycomb structure including a plurality of cells, each cell of the plurality of cells including a cell wall surrounding a void,
the metallic abradable including at least one metallic alloy and a plurality of hollow particles and filling the voids of each cell of the plurality of cells.

14. The method of claim 13, further comprising, prior to applying the filled honeycomb structure to the at least one steel part:
filling the voids of each cell of the plurality of cells with the metallic abradable and bonding the metallic abradable to the cell walls.

15. The method of claim 13, wherein applying the honeycomb structure to the at least one steel part includes bonding both the metallic abradable and the cells walls of the honeycomb structure to a surface of the at least one steel part.

16. The method of claim 13, wherein the at least one metallic alloy includes a braze alloy and the plurality of hollow particles includes hollow fly ash particles.

17. The method of claim 16, wherein the braze alloy is Ni-Cr_{7%}—Si_{4.5%}-Fe_{3%}—B_{3.2%}—Ti_{4.5%}, the percentages being weight percentages and the balance being nickel (Ni).

18. The method of claim 13, wherein the at least one metallic alloy includes MCrAlY-NiAlₓ where M is one or more of Fe, Co and Ni and x is 20% or greater, and the plurality of hollow particles includes at least one selected from the group consisting of zinc oxide, silicon oxide, aluminum oxide, zirconium oxide, cerium oxide, and hydroxyapatite.

19. The method of claim 18, wherein the metallic alloy includes CoNiCrAlY—NiAl_{20%} and the plurality of hollow particles includes zinc oxide, the abradable material including greater than 22% by weight of the zinc oxide.

20. The method of claim 13, wherein the at least one steel part is a 304-grade stainless steel part or a 310-grade stainless steel part.
